(19) United States
(12) Patent Application Publication
(10) Pub. No.: US 2026/0226879 A1
(43) Pub. Date: Aug. 6, 2026

(54) UNDERWATER, SEA AND OCEAN SUBMERSIBLE HYDRO POWER PLANT AND METHOD

(71) Applicant: Asokan B, Chennai (IN)

(72) Inventor: Asokan B, Chennai (IN)

(21) Appl. No.: 19/152,968

(22) PCT Filed: Feb. 15, 2024
(86) PCT No.: PCT/IN2024/050153

§ 371 Date: Aug. 1, 2025

(30) Foreign Application Priority Data
Feb. 17, 2023 (IN) 202341010863

(51) Int. Cl. F03B 13/10; E02B 1/00; E02D 29/063

(52) U.S. Cl. CPC F03B 13/10; E02B 1/006; E02D 29/063; F05B 2220/706

(57) ABSTRACT

An underwater, sea or ocean submersible hydro power plant system to generate electricity, which includes a chamber comprising a storage container, turbine, generator, transformer, and a floating electric power transmission system, with the chamber connected to a walk-through tunnel, and a maintenance and service station. The hydro power plant system is submersed underwater, or under a sea or an ocean, or submersed in any ‘water or fluid body, or a water-tank. The inflow-lid of the storage is opened to let water flow into the storage, A sluice at the bottom of the storage is opened to let the water gush down and rotate the turbine, which in turn rotates the generator, which produces electricity. The transformer in the chamber and the floating transmission system transmits the electricity to the onshore electricity grid.

The present application is related to the following Indian Patent Application, which is, to the extent the terms and/or parts of it does not conflict with this disclosure, incorporated herein by reference:
(1) Indian Patent Application number 202341010863, filed on Feb. 17, 2023

### BACKGROUND

Generating or producing electricity using various means is one of the biggest challenges and demands the world is facing for the last few decades. The related measures to control pollution has been an equally, if not, a larger challenging issue. However, the various means of generating electricity, such as, coal, nuclear, thermal, hydro, solar, and wind powers pose their own limitations, drawbacks, and challenges from dependence of some form of energy and also its cost, safety issues to environmental hazards to seasonal to social issues, such as, huge costs, dislocation of people and other environmental pollution, limitations such as resources, seasonal, national and political angles, etc. Solar Power is limited to the summer season, life-cycle of the batteries, maintenance, costs, areas, limited area scope, etc. Wind power is also seasonal, with emerging issues of interference in hatchings by bird species, huge costs of investment, and additional costs and technology to keep them running in cold and icy temperatures. Offshore wind power has also impacted marine life including accidental deaths of whales, marine species, etc. In the conventional generation of electricity, hydro plants depend on huge flows of water, designs and construction of dams dislocating people, water stagnation causing pollution, other issues of flooding in case of heavy rainfall, etc. Thermal power plants using coal causes huge environmental pollution and dangerous to operate. Nuclear sources come with huge risk of nuclear leaks, catastrophic impact on lives and environment in case of leaks or explosions, the disasters of which the world has witnessed.

The quest for an efficient, cheap, all seasonal, pollution free source of generating electricity is one of the most serious subjects under the focus of the world communities, countries, and global leadership. With the rise in artificial intelligence and the energy requirements for the computer servers to keep them cool has resulted in another bigger demand and expectation for newer sources to generate electricity.

Due to the limited natural resources, various challenges, and issues as stated in the preceding paragraphs, generating electricity to meet the ever-rising energy demands of the world remains a top priority of the global community and there is no existing technology that can generate electricity that is perpetual, pollution-free, green, safe, cheap, efficient, all-seasonal, least impacting, and also independent of the known forms of various energies, such as, solar, wind, thermal, nuclear, etc. Therefore, there is a need that exits to solve the serious shortcomings and inadequacies in the existing resources and technologies to generate electricity. What is needed is an invention that solves these existing challenges in generating electricity.

There is no existing system or prior art, which (i) makes similar disclosure as in this disclosure, (ii) anticipates or claims any system or product and/or method, (iii) similarly enables the same structure and function of the product system, (iv) has similar technical features, (v) has similar embodiments, function, and structure, as in this disclosure. There is no existing system or prior art, that would make this disclosure obvious. The present disclosure solves the problem of providing an inventive, novel, non-obvious, practical product system with industrial applicability to generate electricity using seawater or any suitable water-body or suitable fluid compared to the background literature in the field of generating electricity through hydro power machine or apparatus or hydropower plant system. This background includes the purposes of the invention disclosure and do not limit the body of the claims.

Reference to any prior art in the specification is not, and should not be taken as, an acknowledgment, or any form of suggestion, that the prior art forms part of the common general knowledge in any jurisdiction or that the prior art could reasonably be expected to be ascertained, so understood and regarded as relevant by a person skilled in the art.

### THE FIELD OF THE INVENTION

This present invention relates to the field of generating electricity using hydro power and gravity including the invention product configured in varying sizes and numbers as required, and the product is configured for submerged use under sea of ocean, or river, or lakes, or any suitable water body or artificial water tanks and also, potentially, for automobiles, for generating hydro-power electricity. (FIG. 1. FIG. 1A, FIG. 2, & FIG. 3)

### SUMMARY OF THE INVENTION

An aspect of the disclosure advantageously provides a new, efficient underwater, sea and ocean submersible hydro power plant apparatus system.

According to an embodiment enabled by this disclosure, an underwater, sea or ocean submersible hydro power plant may be provided including a chamber that may contain a storage, turbine, generator and a tunnel, a maintenance and service station, and an electric power transmission component of the embodiment. The hydro power plant may be placed underwater, or under a sea or an ocean, or submersed in any water body, or a water-container and is a submersible hydro power plant. This invention disclosure comprises a chamber, which may comprise turbines and generator; an under-water walk-through tunnel connecting the under-water chamber to a maintenance and service station placed above the water surface; and a floating power transmission connected from the chamber and transmits power to the onshore grid.

In an aspect, a chamber, made of any suitable material including corrosion-resistant steel, or titanium, or carbon-fiber, or alloy, is submersed in the sea or ocean or in such sitable depth in a large water body, such as a lake or a river or an artificial water-body such as a water-tank. An elevator and/or ladder may be provided inside the chamber to climb to the top and the bottom of the chamber. The entire chamber's exterior bottom is provided with water or air or gas filled floats, buoys, and ballasts as required and the chamber is connected to the seabed through tension leg platforms and/or by chained anchors. There are tugs at either sides of the chamber to move the entire chamber from one location to another within the ocean or water-body. The side or rear wall of the chamber or each chamber may have a door connecting to a walk-through tunnel.

In another aspect, another top lid may be provided to act, including, as a sealant to function, including, as an overall cover over the inflow pipe. This sealant lid may be placed at the top over and above the net and the inflow lid or inflow gate.

In another aspect, a strong net may be provided below the top lid to filter out fish, and other extraneous things, and also to prevent trash or extraneous materials from entering the chamber.

In another aspect, below the net, an inflow lid or inflow gate may be provided for providing the inflow of water to the storage reservoir container inside the chamber. This inflow gate may be opened and closed by technology including computer controlled system, also operable manually and semi-manually such as a mechanical system, and also by way technology including sensors.

In another aspect, the storage tank or container or reservoir may be filled with seawater, water or any suitable fluid. The storage tank's bottom may comprise the main sluice that may stop and comprises the water storage in the storage tank or container or reservoir.

In another aspect, after about every few minutes of duration, the sluice at the bottom of the storage may be opened to gush down the storage water. With the help of gravity, the gushing sea water passes through and operates the master turbine.

In another aspect and as the preferred embodiment, the master turbine may operate with the force of the gushing water from the storage. The generator above the turbine may be driven by the turbine and the generator may generate electricity. After the rotations, by the force of the gushing water from the storage and down through a penstock, the master turbine may discharge the water axially by its centrifugal force, through a draft pipe or vent, back into the ocean.

The master turbine may, including as an alternative embodiment, discharge the water through a slanting narrow outflow pipe fitted with an additional turbine. The water is finally discharged back into the ocean of the water body container through this narrow outflow exhaust pipe.

In another aspect, an under ocean submerged walk-through tunnel made of any suitable material including corrosion-resistant steel, or titanium, or carbon-fiber, or carbon-fiber polymer, or rubber, or alloy, may be connected to the chamber housing the turbine and generator. In case of multiple chambers, the tunnel may connect to each chamber through a separate door through a vestibule. This entire tunnel connects the chamber to a maintenance and service station placed above the ocean or water body's surface. There may be access including elevators and/or ladders at both ends of the tunnel to walk up to and down from the maintenance and service station on one end and the storage on the other end. This tunnel may serve the purposes including human physical access to the chamber, inspection, and maintenance works and as a conduit including for the technology and other communication channels.

In another aspect, there may be a power transmission component including towers and transformers as required. This floating power transmission may carry insulated electric power cables, from the generator and the transformer in the chamber to the onshore electricity grid. Each tower in this transmission may carry the electricity lines, may float across the surface waters of the ocean or water-body, and it may finally connect to the onshore power transmission grid. The power lines of the transmission may be connected through insulated cables stretching outside of the chamber and may be connected through the chamber and to the generator and transformer. The transmission towers carrying the required transformers and electricity power lines may be set on floaters and water or air or gas filled floats, buoys, and ballasts as required, and may float on the waters. Each of these floaters may be connected to the seabed or waterbed or to the bottom of any fluid container by a tension leg platform and/or by chained anchors.

In another aspect, there is a maintenance and service station, which may float on the surface of the water or it may be on the exterior from the chamber. It may be accessed and connected by access means including elevator and/or ladder through the walk-through tunnel. The access, communication, and operation systems to the chamber may be through the maintenance and service station. It may include technology including computers, software, sensors, hydraulics, lever, and manpower and other resources that may be required to access, operate, and maintain the chamber. The maintenance and service station may be set up on including floaters, buoys, and ballasts as required, and may float on the waters and may be connected to the seabed or waterbed or to a bottom of any physical body including fluid by a tension leg platform and/or by chained anchors.

According to an embodiment enabled by this disclosure, a method of generating hydropower electricity is provided, which may include the steps of including a storage container submersed in ocean or water or any suitable fluid; filling the storage with water; opening the bottom of the storage by including technology, manual, or other means; letting the sea water or fluid to gush down by force of gravity through a turbine.

In another aspect, the method may include the step of using a turbine that may be rotated by the sea water gushing down the storage by gravity and the turbine may be operating a generator, which may generate electricity.

In another aspect, the method may include the step of connecting and transmitting the electricity from the generator to the onshore electricity grid.

Terms and expressions used throughout this disclosure are to be interpreted broadly. Terms are intended to be understood respective to the definitions provided in this specification. Technical dictionaries and common meanings understood within the applicable art are intended to supplement these definitions. In instances where no suitable definition can be determined from the specification or technical dictionaries, such terms should be understood according to their plan and common meaning.

Various objects, features, aspects, benefits, and advantages described by this disclosure will become more apparent from the following detailed description, along with the accompanying drawings in which like numerals represent like components.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments illustrated herein are presently preferred, it being understood, however, that the invention is not limited to the precise arrangements and instrumentalities shown. This invention is defined by the scope of the appended claims and not the illustrations and examples provided in the drawings. Exemplary embodiments of the present invention is illustrated by way of example in the accompanying drawings in which like reference numbers indicate the same or similar elements and wherein;

FIG. 1 illustrates an exemplary chamber comprising the storage, turbine, generator, and the related components thereof, according to an exemplary embodiment of this disclosure.

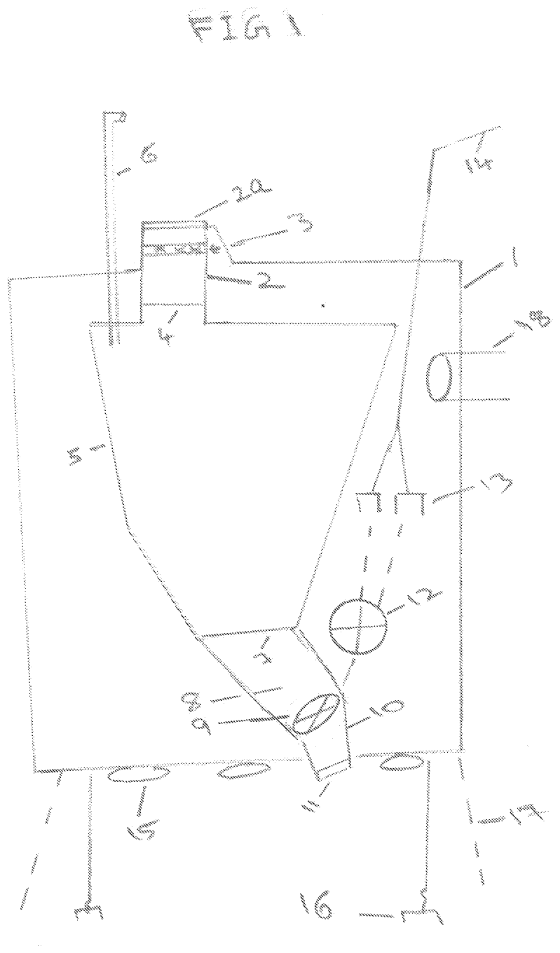

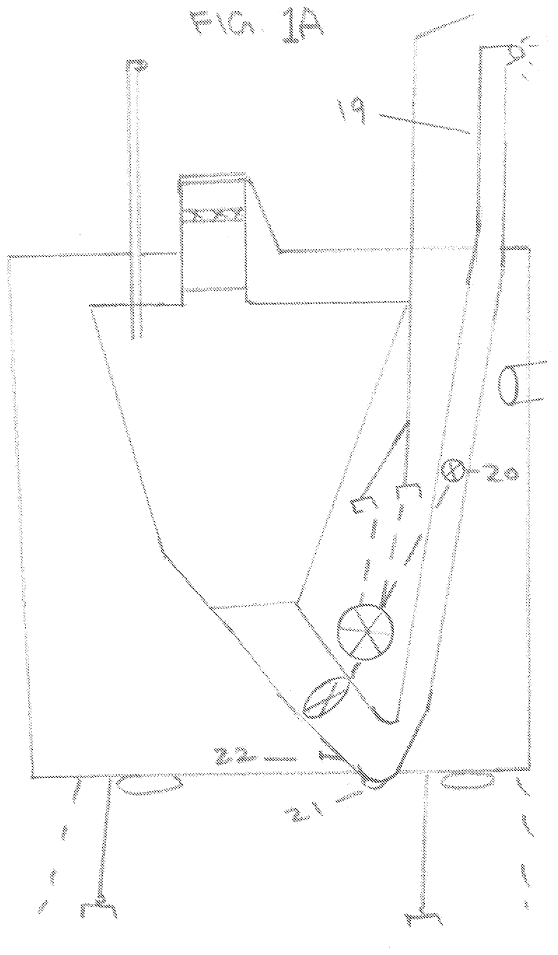

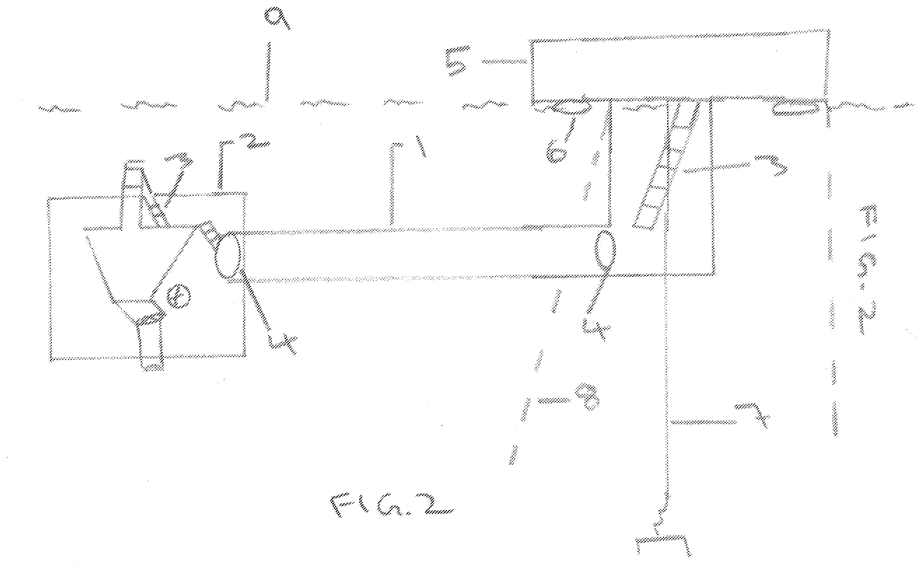

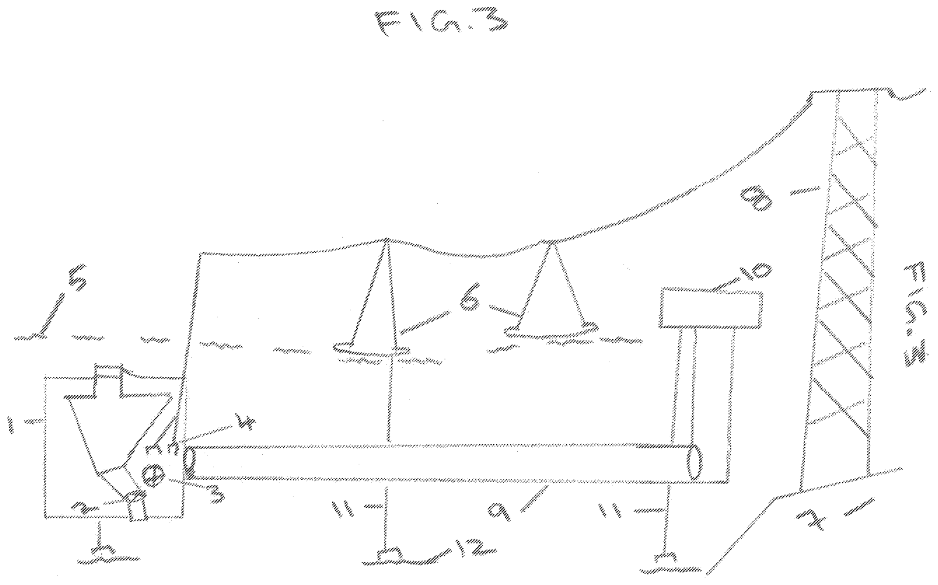

The various aspects and components comprising the chamber are serialized in FIG. 1 are as follows:

| Reference Number | |
|---|---|
| in FIG. 1 | Reference Name |
| 1 | Chamber |
| 2 | Inflow Pipe |
| 2a | Top lid or Top Gate, |
| 3 | Net |
| 4 | Inflow Gate or Inflow Lid, |
| 5 | Storage Container |
| 6 | Air Pipe and Caution Flag Post |
| 7 | Sluice |
| 8 | Pen stock space |
| 9 | Turbine |
| 10 | Draft Tube |
| 11 | Draft Lid |
| 12 | Generator |
| 13 | Transformer |
| 14 | Transmission |
| 15 | Water or air or gas filled floats and buoys |
| 16 | Tension Leg Platform |
| 17 | Tugs and Chained Anchors |
| 18 | Door to Walk-through Tunnel |

FIG. 1A illustrates an exemplary alternative embodiment comprising the chamber, storage, main turbine, exhaust turbine, generator, and the related components thereof, according to another exemplary embodiment of this disclosure. The various aspects and components comprising the chamber include all the references in the table above for FIG. 1 and in the alternative embodiment, additionally include components, which are serialized in FIG. 1A, which are as follows:

| Reference Number | |
|---|---|
| in FIG. 1A, | |
| Alternative Embodiment | Reference Name |
| 19 | Outflow Pipe |
| 20 | Exhaust Turbine |
| 21 | Drain Vent |
| 22 | Drain Vent Pulley |

FIG. 2 illustrates an exemplary walk-through-tunnel comprising access to one or multiple chambers and to the maintenance and service station and also illustrates an exemplary maintenance and service station, and the related components thereof, according to an exemplary embodiment of this disclosure. The various aspects and components comprising the walk-through-tunnel are serialized in FIG. 2 are as follows:

| Reference Number | |
|---|---|
| in FIG. 2 | |
| Walk-Through Tunnel | |
| And Maintenance and Service Station | Reference Name |
| 1 | Walk-through Tunnel |
| 2 | Chamber |
| 3 | Access |
| 4 | Door and Dock |
| 5 | Maintenance and Service Station |
| 6 | Floats, Buoys, and Ballasts |
| 7 | Tension Leg Platform |
| 8 | Tags and Chained Anchors |
| 9 | Ocean or Sea Surface Waters |

FIG. 3 illustrates an exemplary power transmission and also illustrates an exemplary, the entire underwater, undersea and under-ocean submersible hydro power plant system and the components thereof including the chamber, the walk-through tunnel, floating power transmission, and the maintenance and service station, according to an exemplary embodiment of this disclosure. The various aspects and components comprising the transmission and the entire underwater, undersea and under ocean submersible hydro power plant, are serialized in FIG. 3 are as follows:

| Reference Number | |
|---|---|
| in FIG. 3, Transmission | |
| and the entire Underwater, | |
| Undersea and Under-Ocean | |
| Submersible Hydro Power Plant | |
| System | Reference Name |
| 1 | Chamber |
| 2 | Turbine |
| 3 | Generator |
| 4 | Transformer |
| 5 | Sea or Ocean Surface Waters |
| 6 | Floating Power Transmission |
| 7 | Land |
| 8 | Onshore Grid |
| 9 | Walk-Through Tunnel |
| 10 | Maintenance and Service Station |
| 11 | Tension Leg Platform |
| 12 | Sea Bed or Ocean Floor |

### DETAILED DESCRIPTION

The following disclosure is provided to describe various embodiments of an underwater, sea and ocean submersible hydro power plant system. Skilled artisans will appreciate additional embodiments and uses of the present invention that extend beyond the examples of this disclosure. Terms included by any of the claims are to be interpreted as defined in the standard dictionaries and as defined within this disclosure. Singular forms should be read to include and disclose the plural alternatives and the plural forms should be read to contemplate and disclose singular alternative. Expressions such as “one of”, “one of A, B, and C” should be read to permit any of or any of A. B, or C singularly or in combination with the remaining elements. Additionally, such groups may include multiple instances of one or more elements in that group which may be included with other elements of the group. All numbers, measurements, and values are given as approximations unless expressly stated otherwise.

This disclosure provides illustrative embodiments by describing an underwater, sea and ocean submersible hydro power plant system and also the method associated with the said system. All of the implementations described below are exemplary implementations provided to enable persons skilled in the art to practice the disclosure and are not intended to limit the scope of the appended claims. There is no intention to be bound by any express or implied statement or theory was presented in the preceding technical field, background, summary or the following detailed description. The illustrative embodiments may be implemented or incorporated in other embodiments, variations and modifications, and may be practiced or carried out in various ways. Further, unless otherwise indicated, the terms and expressions used herein are for the purpose of describing the illustrative embodiments for the convenience of the reader and are not for the purpose of limitation thereof.

Various aspects of the present disclosure will now be described in detail without limitation. Those of skill in the art will appreciate the labelling of the underwater, sea and ocean submersible hydro power plant system as a hydroelectric power generation system, the invention, or other similar names. Skilled readers should not view the inclusion of any alternative labels as limiting in any way.

In one or more embodiments, an underwater, sea and ocean submersible hydro power plant system is disclosed without limitation. The system may comprise a chamber including a turbine, a generator, and the chamber may be connected to a walk-through tunnel, a maintenance and service station, and a power transmission system.

The systems and methods enabled by this disclosure may allow water-body such as the seawater to be filled in the storage container in the chamber. The storage may be opened to fill the storage with seawater and then the bottom of the storage may be opened to let the stored seawater gush down with force to rotate the turbine blades resulting in electricity being generated by the generator and transmitted by the offshore transmission structure connected to the onshore power grid and/or also may be used in other embodiments that will be appreciated by a person of skill in the art. The chamber may also be connected by a single or multi-door tunnel with each door connecting to a chamber in case of multiple chambers. A maintenance and service station may also be connected to the tunnel for providing technology and manpower controls for the use and operations of the chamber, storage, turbine, generator, transmission and for the overall use of the plant, which may include all of the preceding aspects of this plant.

Referring to FIG. 1, an exemplary underwater, sea and ocean submersible chamber FIG. 1 may function as a container including the storage, turbine, and generator, to utilize the force of the ocean water filled in the storage and allowed to flow down by opening the sluice at the bottom of the storage. In the embodiment, the underwater, sea and ocean submersible chamber FIG. 1 and/or multiple chambers comprised in the underwater, sea and ocean submersible hydro power plant system, may advantageously be deployed to function as an electricity power generating source. The chamber may be made of corrosion resistant steel or alloy or any suitable material and, may be submersed in about 4 to 40 meters depth in the sea or ocean or large water body, such as a lake or a river or an artificial water-body or in a suitable fluid in a container. The chamber may include and comprises of the following:

Referring to FIG. 1, a large storage reservoir container FIG. 1, 5 with narrow slanted bottom which may taper down and blocked by a sluice 7. The top of the storage contains an inflow 2 opening to let and fill water into the storage. The mouth of the inflow may be covered with a strong net 3 with protective mesh to safely filter out fish, and other extraneous things, and also to prevent trash or extraneous materials from entering the chamber. On one side of the inflow pipe, the net may be hooked to the outside of the inflow pipe. On the other side of the inflow pipe, the mesh may be fitted and rolled on to circular rod like shaft for rolling the net in and out between both sides. Above the net, the inflow's mouth may be covered by a top lid or top gate 2a which may serve as a closing seal door to the inflow 2. This top lid may be opened and closed for maintenance of the chamber and may be operated including by technical and manual ways. The chamber's casing may taper down towards the top so as to encase and have the mechanical hinges and operable parts of the top lid to be within the chamber, but the top lid 2a itself may be placed outside of the chamber to open to allow the ocean waters enter the inflow and to close when required for maintenance around the inflow pipe 2 to attend to the net 3, the inflow lid 4 and the top lid 2a.

Below the net, there may be an inflow lid 4 which may be opened and closed both by technology including computers and software, connected via the tunnel and may finally be controlled at the maintenance station. The inflow lid 4 may also be operable manually or semi-manually and/or by combinations of technology, manual, semi-manual, and mechanical system to operate at a specified time-limits, such as, about every few minutes. There may be an air-pipe 6 connecting from the storage container 5 and stretches out of the chamber vertically outside of the sea surface, which also contains an alert red flag with red alert light for night time warning. This air-pipe may serve to remove any air-block and to circulate air inside the storage 5.

Below the inflow pipe, there may be a storage container 5 which may have a suitably designed narrow slanted bottom, which may taper down and blocked by a sluice 7. Once the inlet may be opened about every few minutes through technology operations from the maintenance station, the storage container 5 may be filled with the seawater. The storage container's bottom may contain the main sluice 7 that stops and contains the water storage in the tank. After every storage cycle in about a few minutes duration, the bottom sluice opens and gushes down the storage water through a short penstock space 8 and with the help of gravity, gushes the water down through the turbine 9 placed sufficiently closer to the penstock space 8 and the penstock space may be at sufficient height and distance from the turbine so as to gush down the storage water at its maximum pressure and force down through the turbine. The turbine may operate with the force of the gushing water from the storage. The generator 12 above the turbine may be driven by the turbine and the generator may generate electricity. After the rotations by the force of the gushing water from the storage 5 and penstock space 8, the turbine may discharge the water axially by its centrifugal force, through a draft tube or pipe 10 back into the ocean.

A draft lid 11 may be provided at the bottom end of the draft, to be opened and closed through technology including computers and software, connected via the tunnel and may finally be controlled at the maintenance station. The draft lid 11 may be opened and closed simultaneously with the inflow lid 4 or few seconds or minutes apart. The draft lid 11 may be used for various purposes including to prevent the sea water or water-body entering upwards into the draft and also to carry out maintenance works. The draft lid may also be operable manually or semi-manually and/or by combinations of technology, manual, semi-manual, and mechanical system to operate at a specified time-limits, such as, about every few minutes.

Referring to FIG. 1A, in an alternative embodiment, the water, which gushes down with force, may be allowed to flow upward through a narrow pipe FIG. 1A, 19 which serves as the outlet 19 and flows out the water back into the sea or in the case of artificial tank, back on to the top of the tank itself, which may be used to flow down back again into the inlet in the next cycle and this cycle may be repeated in the embodiment of an artificial container or tank. In this alternative embodiment, at the middle of the narrow outflow pipe, another exhaust or secondary turbine 20 may also be placed. As the water may be discharged from the master turbine FIG. 1, 9 it may flow out through the outflow pipe FIG. 1A, 19. The exhaust turbine FIG. 1A, 20 placed in the outflow pipe may operate with the force of the water released through the master turbine. The secondary turbine may also be connected to the generator, which may further be rotated and driven by the exhaust turbine and the generator may generate more electricity. In this alternative embodiment, there may be a drain vent 21 provided at the bottom exterior of the chamber. The bottom vent 21 may be placed close to the draft from the master turbine, placed outside of the chamber. The vent may extend outside of the bottom of the chamber from which water from the storage may be drained during operations and maintenance by ways of technology and manually. This meeting point resembles almost a “V” and/or “U.” There may be a drain vent pulley 22, which may be inside the chamber, operable both manually by the pulley and/or through technology from the maintenance station FIG. 2.

The entire Chamber's bottom may be provided with water or air or gas filled floats, buoys, and if required, ballasts FIG. 1, 15, to keep it from sinking, and the chamber may be connected to the seabed through tension leg platforms and/or by chained anchors 16. There may be tugs 17 at both sides of the chamber, which may serve to make the chamber mobile inside the waters to relocate the chamber to another location in the ocean or the water-body. The chamber's vertical rear wall may be provided with a vestibule type door 18 to connect to the walk-through tunnel FIG. 2. The chamber may also be provided with technology including computer and software for independent operation of the chamber and the storage to continue to generate electricity in cases when the tunnel and/or the maintenance and service station are detached.

Both the master turbine and the outflow turbines may be connected to the generator FIG. 1, 12, which is placed inside the chamber and may be placed on top of the master turbine 9. The outflow exhaust turbine may also be connected to the generator by a shaft and other sufficient means. The generator 12 may produce electricity when the storage water gushes down and rotates the master turbine 9 and the exhaust turbine 20. The power lines from the generator may be connected through a transformer and insulated cables stretching outside of the chamber through a conduit to the floating transmission lines and towers FIG. 1, 14 and FIG. 3, 6. This transmission lines 14 may be set on floaters FIG. 3, 6 using buoys to float on the ocean surface waters and finally, the electricity generated by the turbine and the generator of the underwater, undersea and under-ocean submersible hydro power plant system, may be transmitted to the onshore transmission grid and power station FIG. 3, 8. Each floater FIG. 3, 6 may be connected to the seabed FIG. 3, 12 by tension leg platforms and/or by chained anchors II.

Referring to FIG. 2, there may be a walk-through tunnel FIG. 2, 1 connecting the rear wall or the wall of the chamber. This walk-through tunnel may serve as the connecting link between the chamber FIG. 2, 2 and the maintenance and service station FIG. 2, 5, which may be at the sea surface 9. There may be a single, standalone chamber or multiple chambers, with each chamber having its own turbine and generators producing hydro power electricity in the manner provided in this description. The rear wall of the chamber or in case of multiple chambers, each chamber's wall may be connected to the walk-through tunnel through doors 4. The walk-through tunnel may serve for multiple purposes including access, operations, hardware, technology control systems, connections, and as conduit for wires and other required infrastructure between the chambers and the maintenance and service station. Both ends of the tunnel may be provided with access 3 means including elevator and/or ladders to climb up and down to reach the top of the storage container within the chamber for purposes including access, repair, and maintenance of inflow lid, mesh and the top lid. At the other end, the access may be used to climb up and down to reach the maintenance and service station and also provided with a strong water sealant door 4 with access to dock to the door of the maintenance and service station. The tunnel may also be provided with technology including computer and software for independent operation of the chamber in cases when the maintenance and service station is detached.

Referring to FIG. 2, there may be a maintenance and service station. This station may serve as the control station to operate the chamber, storage's inflow lid, and the bottom sluice through technology including computers and software. The station may also have manually operated hydraulic pulleys to open the top lid, inflow lid, and the bottom sluice of the storage. The station may be fixed to the seabed through a tension leg platform 7 and/or by chained anchors, and if required, the bottom of the station may be supported with water or air or gas filled float, buoys and/or ballasts 6. The maintenance and service station may be provided internet and telecommunication systems and it also houses the crew members of the hydro power plant system. It may be provided with helipad, motorized engines to additionally function as a boat in situations, including natural calamities, to detach from the tunnel and the chamber, so that the crew members may reach the shore for safety or also when it is required to relocate the chamber the walk-through tunnel, and the entire underwater, undersea and under-ocean submersible hydro power plant system. The maintenance and service station may be provided with a strong water sealant door 4 with vestibule type access to dock to the door 4 of the walk-through tunnel and access by means including elevator and/or ladder 3 to climb down and up from the tunnel. The crew members may be able to access and enter the tunnel, the chamber, the top of the chamber, and the maintenance and service station.

Thus, the above invention disclosure solves the long-standing problem of humanity to find a low-cost, perpetual, environment-friendly, and efficient system to generate electricity by this disclosure: underwater, undersea and under-ocean submersible hydro power plant system. The present disclosure solves the problem of providing an inventive, novel, non-obvious, practical product system with industrial applicability. Based on this disclosure, a skilled worker can make the invention and obtain the results as claimed in the following claims.

With respect to the above description, it is to be realized that the optimum dimensional relationship for the various components of the invention described above and in FIGS. 1 to 5 include variations in size, materials, shape, form, function, and manner of operation, assembly, and use, and are deemed readily apparent and obvious to those skilled in the art, and all equivalent relationships to those illustrated in the drawings and described in the specification are intended to be included by this invention.

Skilled artisans will appreciate additional methods within the scope and spirit of this invention disclosure for performing the operations provided by the examples below after having the benefit of this disclosure. Such additional methods are intended to be included by this disclosure.

While various aspects have been described in this disclosure, the description of this disclosure is intended to illustrate and not limit the scope of the invention. The reference numbers provided in the description and the claims are for easy reference to the features in the diagrams. These reference numbers do not, in anyway, limit the claims. The drawings are illustrative of one or more embodiments of the invention. This invention is defined by the scope of the appended claims and not the illustrations and examples provided in the above disclosure. Skilled artisans will appreciate additional aspects of this invention, which may be realized in alternative embodiments, after having the benefit of this disclosure. Other aspects advantages, embodiments, and modifications are within the scope of the following claims.

It shall be noted that those skilled in the art will readily recognize numerous adaptations and modifications which can be made to the various embodiments of this present invention, which may result in an improved invention, yet all of which may fall within the spirit, scope, of the present invention as defined in the following claims. Accordingly, this invention is to be limited only by the scope of the following claims and their equivalents.

Although the various embodiments of the devices have been described herein in connection with certain disclosed embodiments, many modifications and variations to those embodiments may be implemented. Also, where materials are disclosed for certain components, other materials may be used. The foregoing description and the following claims are intended to cover all such modification and variations.

Any patent, publication, or other disclosure material in whole or in part, that is said to be incorporated by reference herein is incorporated herein only to the extent that the incorporated materials does not conflict with the existing definitions, statements, or other disclosure materials set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein the above disclosure will only be incorporated to the extent that no conflict arises between that incorporated material and the existing disclosure material.

### Definitions

For the purpose of clearly describing the components and features discussed throughout this disclosure, some frequently used terms are now defined without limitation.
Float: As used in this object, float refers to an object that is buoyant, or does not sink into a liquid and may include buoys and ballasts.
Fluid: As used in this disclosure, hydraulic refers to a state (phase) of matter that is liquid and that maintains, for a given pressure, a fixed volume that is independent of the volume of the container.
Force of Gravity: As used in this disclosure, the force of gravity refers to the force or a thing Seo which a body or object draws toward. The force of gravity indicates the direction of the pull of gravitational force on an object at or near the surface of the earth,
Generator: In this disclosure, generator is an electric generator is a device that converts a form of energy into electricity. The force of the fluid on the blades spins (rotates) the rotor shaft of a generator. The generator, in turn, converts the mechanical (kinetic) energy of the rotor to electrical energy. A generator comprises stator and rotors. The stator is a stationary hollow cylindrical structure that forms a magnetic field. The rotor is a rotating cylindrical structure that is coaxially mounted in the stator. The rotation of the rotor within the stator physically generates the electrical energy.
Hydraulic: As used in this disclosure, hydraulic refers to a device wherein the movement of the device is powered using a fluid under pressure.

Hydroelectric power plant system as it is used throughout this disclosure, is defined as including the chamber, storage, turbine, generator, walk-through tunnel, maintenance and service station, and the offshore floating electricity power transmission system and the components included and as each described separately in this disclosure. It also includes the chamber and transmission structure independently, when detached from the walk-through tunnel and the maintenance and service station as mentioned in detail in the description.
Sea, ocean, water or any water-body: mentioned throughout this disclosure is intended to be interpreted broadly to include other suitable fluids without limitation.
Penstock: a conduit or pipe for conducting water. A sluice or gate or pipe for regulating and controlling water flow to deliver waters to a hydro turbine. The definition may include pipes or long channels that carry water down from the hydroelectric reservoir to the turbines inside the actual power station.
Tension Leg Platform or TLP: It refers to the platform that is held in place by tendons connected to the sea floor. The platform is maintained on location through the use of moorings held in tension by the buoyancy of a hull. The mooring system is a set of tension legs or tendons attached to the platform and connected to a template or foundation on the seafloor. The template is held in place by piles driven into the seafloor. Tension leg platforms may comprise floating hulls usually made of buoyant columns and pontoons.
Turbine: In this disclosure, a turbine is a rotary mechanical device that derives energy from a fluid flow. It converts the kinetic energy of a moving fluid or gas to rotational energy. In common usage, a turbine is generally rotated by the force of the moving fluid or gas through a series of blades arrayed around the circumference of a wheel or a cylinder in the turbine and the turbine converts this force into useful work or another form of energy, such as electricity, when connected to a generator.

1. An underwater, undersea and under-ocean submersible hydro power plant system for generating electricity, comprising:
at least one chamber comprising:
at least one storage reservoir container, housed inside the chamber, including:
an air pipe, connecting from the chamber and stretches out vertically outside of the sea surface, which also contains an alert red flag with red alert light for night time warning, wherein the air-pipe serves to remove any air-block and to circulate air inside the storage container;
an inflow pipe, to allow the ocean waters flow into the storage container of the chamber;
a top lid, to close the inflow pipe when required for maintenance and to open to allow the ocean waters enter the inflow;
a net-placed below the top lid, to safely filter out fish, and also to prevent trash or extraneous materials from entering the storage container, wherein the net is hooked to the outside of the inflow pipe, wherein on the other side of the inflow pipe, the net is fitted and rolled on to circular rod like shaft for rolling the net in and out between both sides;
an inflow lid placed below the net, to open about every few minutes to let sea water fill the storage container and close, wherein the inflow lid is operated both by technology, manually or semi-manually, connected via the tunnel, and finally be controlled at the maintenance station;
a sluice at about the bottom of the storage container but above a penstock space, to contain storage water and open every few minutes to gush down the storage water through the penstock space;
the penstock space, to perform as a conduit to receive the storage water and to gush the storage water over a turbine, wherein the turbine is configured, to rotate by the force of the gushing water down from the storage container and the penstock space, and to rotate a generator, and discharges the gushing water axially back into the ocean or fluid or any water-body;
a draft tube to discharge the gushing water from the turbine; and
a draft lid to open and close simultaneously with inflow lid or about every few seconds or minutes apart for purposes including to prevent sea water entering or interfering into the turbine and for maintenance, wherein the draft lid is operated both by technology, manually or semi-manually, connected via the tunnel, and controlled at a maintenance and service station; OR
an alternative embodiment of the chamber, wherein the main turbine in the alternative embodiment discharges water through an outflow pipe to discharge the water upwardly back into the sea or water-body, wherein the alternative embodiment of the chamber comprises:
the outflow pipe connected to a draft end of the turbine, wherein the outflow pipe is placed close to the draft end, designed and shaped to retain the most possible force and efficient discharge of the water from the turbine;
a drain vent is provided at the bottom meeting point of the draft end and the start of the outflow pipe, which point resembles about a “V” or “U” and the drain vent is positioned outside of the chamber to discharge water during maintenance or when required;
a drain vent pulley is provided on the outer of the draft end and outflow pipe meeting joint, which pulley is operable by technology and also manually from within the chamber;
an exhaust turbine is placed in the middle of the outflow pipe and is connected to the generator, wherein the exhaust turbine is rotated by the force of the discharged water released from the main turbine, wherein the exhaust turbine is connected to the generator, which is further driven by the exhaust turbine and the generator generates more electricity;
wherein the chamber further comprises:
the generator, to produce electricity when the storage water gushes down and rotates the turbine;
at least one transformer, to transmit the electricity from the generator to the offshore floating transmission system;
at least one door to connect to a walk-through tunnel;
independent technology infrastructure including computers and software for independent functioning of the chamber, inflow lid, storage, sluice, turbine, draft lid, and generator, to continue to generate electricity independent of the maintenance and service station; and
floaters and buoys at the exterior bottom of the chamber and tension leg platforms to keep the chamber afloat at a certain depth submersed in water and the chamber connected to the bottom of a water-body floor such as seabed, ocean-floor, or river, or lake-floor, or any natural or artificial water-body container's floor, as a holding means for the chamber to be attached to a certain location in the ocean or any fluid or water-body, and tugs at both sides of the bottom to pull the chamber from one location to another.

2. The underwater, undersea and under-ocean submersible hydro power plant system of claim 1, further comprises:
a floating transmission system, wherein the transmission system is connected to the generator and transformer in the chamber, wherein the floating transmission system comprises towers and insulated electric wires, to transmit the electricity from the generator and transformer to the onshore electricity grid, wherein the transmission system includes towers and required transformers, which is set on floaters, buoys, and ballasts on the ocean or water-body surface and finally connect to the onshore transmission grid and power station, wherein each floater carrying the transmission electric wires and transformer is connected to the seabed by a tension leg platform and/or by chained anchors.

3. The underwater, undersea and under-ocean submersible hydro power plant system of claim 1, further comprises:
a walk-through tunnel, wherein the walk-through tunnel connects the rear wall or the wall of the chamber, wherein the walk-through tunnel connects the chamber or chambers and the maintenance and service station at the sea surface, wherein the walk-through tunnel serves multiple purposes including access, operations, infrastructure, technology control systems, access elevators and/or ladders to reach the top of the chamber for maintenance and to access to and from the maintenance and service station and has strong water sealant doors with vestibule type access to dock to the chamber and the door of the maintenance and service station, wherein the walk-through tunnel is provided with technology including computer and software for independent operation of the chamber.

4. The underwater, undersea and under-ocean submersible hydro power plant system of claim 1, further comprises:
the maintenance and service station, placed above the surface of the sea waters or any water-body, wherein this maintenance and service station serves as the control station to operate the chamber and storage's top lid, inflow lid, and the bottom sluice, turbine, through technology including computers and software;
manually operated hydraulic pulleys to open the top lid, inflow lid, and the bottom sluice of the storage container;
internet and telecommunication systems, housing for maintenance crew members, a helipad, one or more motorized engines to additionally function as a boat, to detach from the tunnel and the chamber;
strong water sealant vestibule type doors to access and dock to the door of the walk-through tunnel and access elevators and/or ladders to climb down and up from the tunnel, wherein the maintenance and service station is fixed to the seabed through a tension leg platform and/or by chained anchors, and the bottom of the station is supported with water or air or gas filled float, buoys, and ballasts.

5. A method of generating electricity through underwater, undersea and under-ocean submersible hydro power plant, the method comprising:
submersing in sea, ocean, river, lake, or any water-body, a chamber including storage container with inflow lid, slanting bottom, a sluice, and at least one turbine.

6. The method of claim 5 further comprising:
filling the storage container with water and containing the water or fluid with a sluice at about the bottom of the storage container above a penstock space.

7. The method of claim 5 further comprising:
opening the sluice of the storage container by including technology, manual, or other means and letting the sea water or fluid to gush down by force of gravity through a turbine.

8. The method of claim 5 further comprising:
letting the turbine rotate the generator by the force of the water or fluid gushing down from the storage container and generating electricity by the generator, which is rotated by the turbine.

9. The method of claim 5 further comprising:
connecting and transmitting the electricity from the generator through transformer and insulated wires through a floating transmission system connected to the onshore power transmission grid.
